(19) United States
(12) Patent Application Publication
(10) Pub. No.: US 2011/0183007 A1
(43) Pub. Date: Jul. 28, 2011

(54) ANTIFUNGAL COMPOSITIONS

(76) Inventors: Michael A. Bilodeau, Brewer, ME (US); Karl D. Bishop, Orono, ME (US); Susan G. MacKay, Veazie, ME (US)

(21) Appl. No.: 13/015,089

(22) Filed: Jan. 27, 2011

Related U.S. Application Data
(60) Provisional application No. 61/298,672, filed on Jan. 27, 2010.
(60) Provisional application No. 61/298,673, filed on Jan. 27, 2010.

(51) Int. Cl. A01N 59/16; B32B 9/04; B32B 13/08; A01N 59/14

(52) U.S. Cl. 424/639; 428/688; 424/660

(57) ABSTRACT

An antifungal composition includes a borate fungicide and an ion-exchange type antimicrobial agent with two or more different metal ions. For example, the ion-exchange type antimicrobial agent may be a zeolite and the metal ions may be magnesium ions and manganese ions. The combination of the metal ions and the borate provide a synergistic effect in fungal resistance.

### CROSS-REFERENCE TO RELATED APPLICATION

This application claims the benefit of U.S. Provisional Application Nos. 61/298,672 and 61/298,673, both filed Jan. 27, 2010, the disclosures of which are incorporated herein by reference.

### BACKGROUND OF THE INVENTION

This invention relates in general to antifungal compositions, and in particular to antifungal compositions that can be added to provide mold resistance to building materials and other materials.

Mold problems can arise in interior living spaces. In the past 30 years as buildings have become better insulated and more energy efficient there has been an increase in mold problems due to trapped moisture. Building materials such as wood, insulation materials and wallboard used in building construction are susceptible to mold and fungal growth in moist environments or when exposed to wetting. Fluffed cellulose fiber, shredded paper, low density fiberboard used as insulating materials and nonwoven webs, such as paper, used to cover gypsum wallboard, are all prime growth media for fungi. Several species of mold and fungus that grow in these environments are toxic to humans. A number of health risks such as occupational asthma, rhinoconjunctivitis, hypersensitivity pneumonitis and organic dust toxic syndrome (ODTS), aspergillosis and histoplasma have been linked to antigens generated by fungi. Diseases associated with inhalation of fungal spores can include toxic pneumonitis, hypersensitivity pneumonitis, tremors, chronic fatigue syndrome, kidney failure, and cancer.

The current mold resistant wallboard technology (DensArmor® Georgia Pacific) consists of a fiberglass based product that has limitations in implementation due to its cost and its density. The shell of DensArmor® is composed of fiberglass. This makes it weigh more than regular wallboard which uses paper as the shell. An ideal mold resistant drywall would be of similar construction as standard drywall but be able to resist mold growth. Ecology Coatings, Inc. has developed a coating for drywall that needs to be cured by exposure to UV light.

It would be desirable to provide an antifungal composition that confers mold resistance to building materials such as loose fill and dense packed cellulose insulation, wallboards and to other materials.

### SUMMARY OF THE INVENTION

In one embodiment, an antifungal composition comprises a borate fungicide and an ion-exchange type antimicrobial agent with two or more different metal ions. The combination of the metal ions and the borate provide a synergistic effect in fungal resistance.

In another embodiment, an antifungal composition comprises an ion-exchange type antimicrobial agent with borate ions and two or more different metal ions. The combination of the borate ions and the metal ions provide a synergistic effect in fungal resistance.

A fungus resistant building material comprises a building material susceptible to fungus growth and an antifungal composition comprising a borate fungicide and an ion-exchange type antimicrobial agent with two or more different metal ions. The combination of the metal ions and the borate provide a synergistic effect in fungal resistance.

Various aspects of this invention will become apparent to those skilled in the art from the following detailed description of the preferred embodiments.

### BRIEF DESCRIPTION OF THE DRAWING

FIG. 1 is a bar graph showing the week at which mold growth was first observed based on paper handsheet compositions in testing done with different additives.

### DETAILED DESCRIPTION OF THE PREFERRED EMBODIMENTS

The present development, relates to an antifungal composition that comprises a borate fungicide and an ion-exchange type antimicrobial agent with two or more different metal ions. The combination of the metal ions and the borate provide a synergistic effect in fungal resistance. The antifungal composition can be effective in providing resistance to one or more types of fungus, such as molds, yeasts, mushrooms and other eukaryotic organisms.

Any suitable borate fungicide can be used in the composition. Borate fungicides are well known in the industry and include, for example, boric acid, sodium borate, borax, sodium tetraborate decahydrate, sodium tetraborate pentahydrate, disodium octaborate tetrahydrate, disodium octoborate, sodium metaborate, sodium perborate, sodium perborate tetrahydrate, sodium pentaborate decahydrate, and the like. In a particular embodiment, the borate fungicide is sodium perborate tetrahydrate, which is available commercially as Polybor® from U.S. Borax Inc., Valencia, Calif.

The ion-exchange type antimicrobial agent can be any suitable type. These agents typically comprise an inorganic ion-exchange carrier and one or more antimicrobial metals and/or metal ions, most preferably one or more antimicrobial metal ions. The inorganic ion-exchange carrier is preferably an ion-exchange type ceramic particle wherein antimicrobial metal ions have been exchanged (replaced) for other non-antimicrobially effective ions in the ceramic particles or a combination of the foregoing with an antimicrobial metal salt. Suitable ceramic particles include, but are not limited to zeolites, hydroxyapatite, zirconium phosphates and other ion-exchange ceramics, and come in many forms and types, including natural and synthetic forms.

The term “zeolite” is used here in its generic sense and refers to crystalline inorganic molecular sieves such as aluminophophates, silicon aluminum phosphates, microporous borosilicates, titanosilicates and tatanioaluminosilicates, as well as microporous aluminosilicates and their silica analogs, having a framework structure consisting of nanopores and interconnected cavities which can be occupied by ions and/or water molecules, both of which have considerable freedom of movement permitting ion exchange and reversible dehydration. In contrast to amorphous materials these crystalline structures contain regular arrays of intracrystalline pores (nanopores) and voids of uniform dimensions. A typical naturally occurring zeolite is the mineral clinoptilolite with formula (Ca, Na, K)₂₋₃Al₃(Al,SO₂Si₁₃O₃₆.12(H₂O). As used herein, “ion exchanged zeolite” refers to a natural or synthetic zeolite that has been modified by an ion exchange process to increase the content of one or more metal ions in the zeolite.

The ion-exchange type antimicrobial agent is modified by exchange with two or more different metal ions. The combination of the metal ions and the borate provide a synergistic effect in fungal resistance. For example, as described in the experiments below, it was discovered that the combination of magnesium ions and manganese ions and the borate provide a synergistic effect in fungal resistance. Using the ASTM D6523 Standard Test Method for Resistance to Growth of Mold it has been demonstrated that this combination is an unexpectedly effective mold inhibitor. However, other combinations of ions may also provide such a synergistic effect.

The experiments below describe the use of silver and zinc ions as well as magnesium and manganese. Some other metal ions known for use in ion exchange materials include, but are not limited to, copper, gold, mercury, tin, lead, iron, cobalt, nickel, arsenic, antimony, bismuth, barium, cadmium, chromium and thallium.

In an alternative embodiment, instead of using a borate fungicide along with the ion-exchange type antimicrobial agent, the antifungal composition can comprise an ion-exchange type antimicrobial agent having borate ions in addition to the metal ions. Any suitable borate ions can be used.

Other embodiments of this technology could include a binder, such as nanocellulose or other natural or synthetic binder, to aid in incorporating and retaining the antifungal composition into or onto the material to which it is applied.

The antifungal composition can have any suitable effectiveness against fungi. In certain embodiments, the antifungal composition scores a 10 in the ASTM D3273 test for mold resistance. Also, in certain embodiments, the antifungal composition is effective to prevent mold growth onset at least about 3 weeks according to mold resistance test ASTM D6523. Such testing is described in the experiments below.

The antifungal composition can be used in many different applications where it is desirable to prevent fungal growth. The antifungal composition may be applied as a coating or may be incorporated into a material. Such applications can involve applying the antifungal composition in or on many different materials. Such materials may include, for example, wood, paper, metal, plastic, glass, or fabric/textile. In certain embodiments, the antifungal composition is incorporated into or coated onto any number of inorganic materials, especially those employed in building construction, like wood, paper, fluffed cellulose fiber, fiberboard, cements, mortar, grout, plaster, and the like, or in the manufacture of building materials, such as ceramics and cements for tiles. In certain embodiments, the antifungal composition is used as a building material additive, for example, in wallboard of any type, more particularly in the paper cover of drywall or in cellulose insulation formulations—both loose fill and dense packed products.

The antifungal composition can be used in any amount suitable for providing fungal resistance. For example, the composition may be used in an amount of from about 1% to about 30% by weight of the material when used as an additive, or by weight of a coating when applied as a coating.

Development and Test of the Innovation

The main goal of this innovation was to identify a zeolite formulation which would inhibit mold growth when incorporated into paper. The scope of work comprised two parts. Part I tested pre-screening of ion exchanged zeolite candidates for mold inhibition on paper handsheets. The best mold inhibitor candidates were chosen for a second round of tests, Part II. Combinations of two metals and metals with Polybor were utilized in making handsheets which were then tested for mold inhibition. Finally, a sample of “drywall paper” with the best performing zeolite was submitted to an ASTM lab in order to test its effectiveness under the ASTM mold resistance test (ASTM D6523).

Part I.

The testing was performed in two stages. The first stage involved preparing a series of handsheets which incorporated a range of zeolite/metal compositions.

Handsheet Compositions

### Hand Sheet Mold Test Key:

| Sheet | Composition |
|---|---|
| A | Ag/CLIN |
| B | Fe/CLIN |
| C | Mg/CLIN |
| D | Mn/CLIN |
| E | Zn/CLIN |
| F | Ti/CLIN (#3- normal pH, exchanged in ethanol, CLIN normal) |
| G | Ti/CLIN (#2- low pH, exchanged in water, CLIN damaged?) |
| H | Zn/50% exchange |
| I | Ag/FAU |
| J | CLIN (unexchanged) |
| K | BLANK |
| L | Polybor |

CLIN: clinoptilolite
FAU: faujasite
Polybor: spray-on boric acid compound

Mold Test Results

Inhibition of mold growth was conducted in Dr. Jody Jellison's lab at the University of Maine. Dr. Jellison is an expert in mold microbiology and performs consulting work for private industry. The choice of mold species was recommended by her and Zeomatrix' experimental design was modified by her to best suit the facilities available and her knowledge of best known practices. The test utilized four mold spores common to domestic environments.

The mold species used in this study are as follows:

Aspergillus niger ATCC 6275

isolated from leather

Aspergillus niger ATCC 9642

isolated from wireless radio equipment, New South Wales, Australia

Cladosporium minourae ATCC 52853

isolated from rotting wood, Japan

Penicillium funiculosum ATCC 11797

isolated from mercury-treated fabric, Maryland

A cocktail of these organisms were prepared from individual cultures obtained from ATCC (American Type Culture Collection). Careful preparation of the cocktail required that each mold species be present at the same concentration (steps 1 through 4). This process required four weeks. Paper samples (5 each) were 4.0 cm diameter circles cut from handsheets and placed in a randomized fashion 4 at a time onto agar plates (step 5). Each plate was inoculated with mold spores by spraying with 10 mL of the spore cocktail (step 6). The plates were incubated at 25° C. in humid conditions for 4 weeks. The plates were photographed each week (step 8). The ability of the paper samples to inhibit mold growth nearby was determined by measuring zones of partial and total inhibition (step 9).

1. Molds Grown on Potato Dextrose Agar (PDA)

2. Spores Collected Using Minimal Salts Solution

3. Spores Counted Using Hemocytometer

4. 10⁵ Spores from Each Mold Added to Spore Cocktail

5. Plates Assembled Using Minimal Salts Solution And Samples

6. 10 mL Spore Cocktail Sprayed onto Each Plate Using Minimal Salts Agar

7. Plates Incubated At 25° C. In Humid Conditions for Four Weeks

8. Plates Were Photographed Regularly

9. Zones of Total and Partial Inhibition Were Measured

Results:

Zones of inhibition showed that handsheets containing zeolites exchanged with silver, and magnesium in combination with boric acid were effective in preventing mold from growing near the paper samples. Samples containing silver, natural zeolite, zinc, and boric acid demonstrated some effectiveness at inhibiting mold growth on the paper samples.

Part II.

Part II of this research effort involved three different exchanged zeolites which exhibited mold inhibition in Part I—Ag, Mg and Zn-exchanged. The Ag-exchanged sample was used as a control and is not a good candidate for a commercial product. However, both the Mg and Zn samples were tested in the follow-on study.

Mold Study

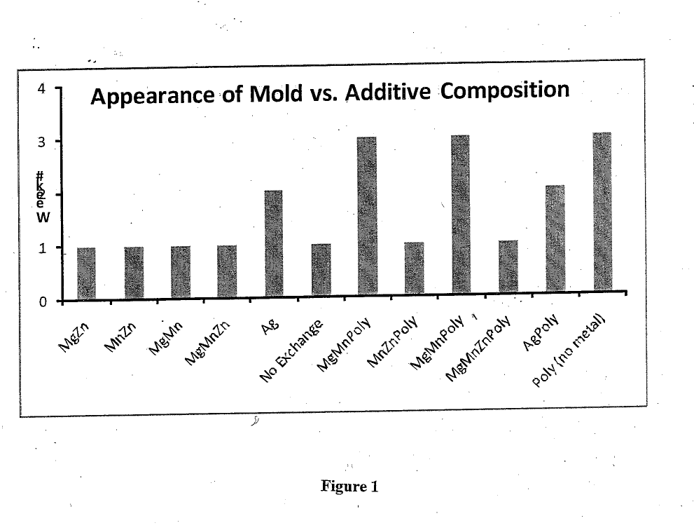

As before, zeolite samples were exchanged by Zeomatrix and handsheets incorporating these zeolites were prepared by the Process Development Center (PDC) at UM. The handsheets were divided up into samples as shown in Table 1 and submitted to Jody Jellison for incubation with the test mold spores. The mold testing was conducted for 8 weeks and the results are in FIG. 1.

TABLE I
Handsheet Sample Compositions

| Handsheet Sample | | |
|---|---|---|
| Number | Exchanged Ions | Composition |
| A | MgZn | 1:1 |
| B | MnZn | 1:1 |
| C | MgMn | 1:1 |
| D | MgMnZn | 1:1:1 |
| E | Ag | Control |
| F | No exchange | Zeolite Control |
| G | MgMn | 1:1, 3.5% Polybor |
| H | MnZn | 1:1, 4.7% Polybor |
| I | MgMn | 1:1, 3.0% Polybor |
| J | MgMnZn | 1:1:1, 4.1% Polybor |
| K | Ag | 3.6% Polybor |
| L | No exchange | 5.0% Polybor |

The exchanged zeolites in the preceding table were incorporated into handsheets in the amounts indicated (1:1, 300 mg:300 mg). The Polybor was applied as a spray-on solution at the various levels indicated. The Polybor is simply a boric acid solution comprised of boron, oxygen, and sodium.

Mold Test

The mold test was conducted as previously described (Part I). The plates were prepared in a double blind study where the biology researchers were unaware of the different compositions of samples A-L. Different samples were randomly grouped on the 5 plates in sets of three in order to test 5 replicates of each composition. The results of the replicates are summarized in the table in Table II.

TABLE II
Summary of Initial Mold Growth for Replicate Samples.

| Growth First | | | | | | | | | | | | |
|---|---|---|---|---|---|---|---|---|---|---|---|---|
| Appeared | A | B | C | D | E | F | G | H | I | J | K | L |
| Day 3 | | | | | | | | | | | | |
| Week 1 | X | X | X | X | | X | | X | | X | | |
| Day 10 | | | | | | | | | | | | |
| Week 2 | | | | | X | | | | | | X | |
| Week 3 | | | | | | | X | | X | | | X |

NOTE: At Week 4, every treatment type had one or more replicates with
mold growth

| | | | | | | | | | | | | |
|---|---|---|---|---|---|---|---|---|---|---|---|---|
| Replicates with | 0 | 0 | 0 | 0 | 3 | 0 | 3 | 1 | 2 | 3 | 4 | 3 |
| no growth at | | | | | | | | | | | | |
| Week 8 | | | | | | | | | | | | |
| Replicates with | 0 | 0 | 0 | 0 | 3 | 0 | 3 | 2 | 3 | 3 | 4 | 3 |
| no growth at | | | | | | | | | | | | |
| Week 6 | | | | | | | | | | | | |
| Replicates with | 0 | 0 | 0 | 0 | 4 | 0 | 3 | 3 | 4 | 3 | 4 | 3 |
| no growth at | | | | | | | | | | | | |
| Week 4 | | | | | | | | | | | | |
| Replicates with | 0 | 0 | 0 | 0 | 4 | 0 | 4 | 3 | 4 | 3 | 4 | 3 |
| no growth at | | | | | | | | | | | | |
| Week 3 | | | | | | | | | | | | |
| Replicates with | 0 | 1 | 0 | 0 | 4 | 0 | 5 | 3 | 5 | 4 | 4 | 5 |
| no growth at | | | | | | | | | | | | |
| Week 2 | | | | | | | | | | | | |

Summary of Innovation Test

The Polybor definitely had a positive effect on the mold resistance properties. The best overall performers (all replicates over eight weeks) were the ones containing either magnesium plus manganese, or silver, plus Polybor. However, the mg:mn plus polybor samples (I and G) were more resistant to mold growth onset than the Ag+Polybor as shown in FIG. 1. This composition (Mg:Mn+polybor) was selected for the drywall test panel. There was a definite synergistic effect of the two metals (Mg and Mn) in combination with Polybor. The result is non-obvious considering that the addition of zinc (MgMnZnP) did not inhibit mold growth more than no exchange at all.

The drywall panel was submitted to Accugen Laboratory in Illinois for the ASTM D3273 test. This test showed that the MgMn Polybor treated drywall sample scored a “10” out of 10, or the highest score for mold resistance.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An antifungal composition comprising a borate fungicide and an ion-exchange type antimicrobial agent with two or more different metal ions, the combination of the metal ions and the borate providing a synergistic effect in fungal resistance.

2. The antifungal composition of claim 1 which scores a 10 in the ASTM D3273 test for mold resistance.

3. The antifungal composition of claim 1 which is effective to prevent mold growth onset at least about 3 weeks according to mold resistance test ASTM D6523.

4. The antifungal composition of claim 1 wherein the metal ions comprise a combination of magnesium ions and manganese ions.

5. The antifungal composition of claim 1 wherein the ion-exchange type antimicrobial agent comprises a zeolite.

6. The antifungal composition of claim 1 wherein the borate fungicide comprises a borate hydrate.

7. The antifungal composition of claim 6 wherein the borate fungicide comprises disodium octaborate tetrahydrate.

8. The antifungal composition of claim 1 wherein the ion-exchange type antimicrobial agent comprises a zeolite and the metal ions comprise a combination of magnesium ions and manganese ions.

9. The antifungal composition of claim 8 wherein the borate fungicide comprises disodium octaborate tetrahydrate.

10. The antifungal composition of claim 1 wherein the ion-exchange type antimicrobial agent consists of a zeolite, the metal ions consist of a combination of magnesium ions and manganese ions, and the borate fungicide consists of disodium octaborate tetrahydrate.

11. An antifungal composition comprising an ion-exchange type antimicrobial agent with borate ions and two or more different metal ions, the combination of the borate ions and the metal ions providing a synergistic effect in fungal resistance.

12. The antifungal composition of claim 11 wherein the metal ions comprise a combination of magnesium ions and manganese ions.

13. The antifungal composition of claim 11 wherein the ion-exchange type antimicrobial agent comprises a zeolite.

14. The antifungal composition of claim 11 wherein the borate comprises a borate hydrate.

15. The antifungal composition of claim 1 wherein the ion-exchange type antimicrobial agent comprises a zeolite and the metal ions consist of a combination of magnesium ions and manganese ions.

16. A fungus resistant building material comprising a building material susceptible to fungus growth and an antifungal composition comprising a borate fungicide and an ion-exchange type antimicrobial agent with two or more different metal ions, the combination of the metal ions and the borate providing a synergistic effect in fungal resistance.

17. The building material of claim 16 wherein the metal ions comprise a combination of magnesium ions and manganese ions.

18. The building material of claim 16 wherein the ion-exchange type antimicrobial agent comprises a zeolite.

19. The building material of claim 16 wherein the borate fungicide comprises disodium octaborate tetrahydrate.

20. The building material of claim 16 which comprises a wallboard.

21. The building material of claim 16 which comprises cellulose fiber insulation.
